(19) United States
(12) Patent Application Publication
(10) Pub. No.: US 2008/0268880 A1
(43) Pub. Date: Oct. 30, 2008

(54) SYSTEM AND METHOD FOR REMOTE OPERATION OF A NODE

(75) Inventors: Thanh Khai Ong, San Diego, CA (US); John J. Wu, San Diego, CA (US)

Correspondence Address: FOLEY & LARDNER LLP, P.O. BOX 80278, SAN DIEGO, CA, 92138-0278, US

(73) Assignee: Novatel Wireless

(21) Appl. No.: 11/740,843

(22) Filed: Apr. 26, 2007

(51) Int. Cl. H04M 3/00

(52) U.S. Cl. 455/466

(57) ABSTRACT

A wireless communication method includes monitoring WWAN signals for a device while a primary processor of the device is in a low-power or power-off mode, determining if a WWAN signal includes a message including instructions to wake up the device, and transmitting a signal to the primary processor to wake up the device if the message includes said instructions to wake up the device.

### BACKGROUND OF THE INVENTION

The present invention relates generally to the field of wireless communications and, more particularly, to the field of remote operation of electronic devices through wireless communication.

Most portable electronic devices have the ability to operate on batteries, such as rechargeable batteries. To conserve battery power, many such devices have a low-power or a power-off mode during which most or all functions of the device are suspended or terminated.

When such devices are part of a network, particularly a private network such as a company's intranet, several problems may arise with the device in a low-power or power-off mode. For example, if a server of the network needs to communicate with the device, the device will not receive any messages while in low-power or power-off mode.

Additional problems can arise if the portable device is lost or stolen. For example, many such devices may contain critical data on their respective local memories. For example, many laptop computers contain large hard drives which may include personal, confidential or otherwise critical data. Similarly, other portable devices, such as personal digital assistants (PDA's) may contain contact lists which may be difficult to reconstruct. With the device inaccessible, the data may be lost forever, particularly if the device is in a low-power or power-off mode when lost or stolen.

### SUMMARY OF THE INVENTION

Embodiments of the present invention effectively and efficiently resolve the issues described above.

One aspect of the invention relates to a wireless communication method. The method includes monitoring WWAN signals for a device while a primary processor of the device is in a low-power or power-off mode, determining if a WWAN signal includes a message including instructions to wake up the device, and transmitting a signal to the primary processor to wake up the device if the message includes said instructions to wake up the device.

In a particular embodiment, the message in the WWAN signal is an SMS message.

In one embodiment, the method also includes determining if the WWAN signal includes a message requesting data backup; and if the WWAN signal includes the message requesting data backup, facilitating a wireless connection between the device and a base server associated with the WWAN signal, and facilitating uploading of data from the device to the base server.

In one embodiment, the device is a portable computer. In a particular embodiment, the device is a wireless communication device.

In another aspect, the invention includes a wireless communication method comprising monitoring WWAN signals for a device, determining if a WWAN signal includes a message requesting data transfer from the device to a base server associated with the WWAN signal, facilitating a wireless connection between the device and the base server, and facilitating uploading of data from the device to the base server.

In one embodiment, the method further comprises determining if a primary processor of the device is in a low-power or power-off mode and transmitting a signal to the primary processor to wake up the device.

In another aspect of the invention, a wireless communication method comprises monitoring, by a wireless module of an electronic device, a base server associated with the electronic device for need to back up data on the electronic device, determining that a data backup is required, facilitating a wireless connection between the electronic device and the base server, and facilitating uploading of data from the electronic device to the base server.

In one embodiment, the method further comprises determining if a primary processor of the device is in a low-power or power-off mode, and transmitting a signal to the primary processor to wake up the device.

In another aspect, the invention includes a wireless device comprising a primary processor having a low-power or power-off mode and a wireless module adapted to monitor SMS messages from a base server to determine if the SMS messages include instructions to wake up the primary processor from the low-power or power-off mode. The wireless module is further adapted to transmit a signal to the primary processor to wake up the primary processor if the message includes said instructions to wake up the primary processor.

In another aspect, the invention includes a wireless device comprising a primary processor, a data storage module and a wireless module adapted to monitor SMS messages from a base server to determine if the SMS messages include a request for a data transfer from the device to the base server. The wireless module is further adapted to facilitate a wireless connection between the device and the base server and to facilitate uploading of data from the device to the base server.

In another aspect of the invention, a wireless device comprises a primary processor, a data storage module, and a wireless module adapted to monitor a base server for need to back up data on the wireless device. The wireless module is further adapted, when a data backup is required, to facilitate a wireless connection between the device and the base server and to facilitate uploading of data from the device to the base server.

### BRIEF DESCRIPTION OF THE DRAWINGS

FIG. 1 is a block diagram illustrating a wireless device according to an embodiment of the present invention;

FIG. 2 is a block diagram illustrating a communication system including the wireless device of FIG. 1 according to an embodiment of the present invention;

FIG. 3 is a flow chart illustrating a method of remote operation of a wireless device according to an embodiment of the present invention;

FIG. 4 is a flow chart illustrating a method of remote operation of a wireless device according to another embodiment of the present invention; and

FIG. 5 is a flow chart illustrating a method of remote operation of a wireless device according to still another embodiment of the present invention.

### DETAILED DESCRIPTION OF THE PREFERRED EMBODIMENTS

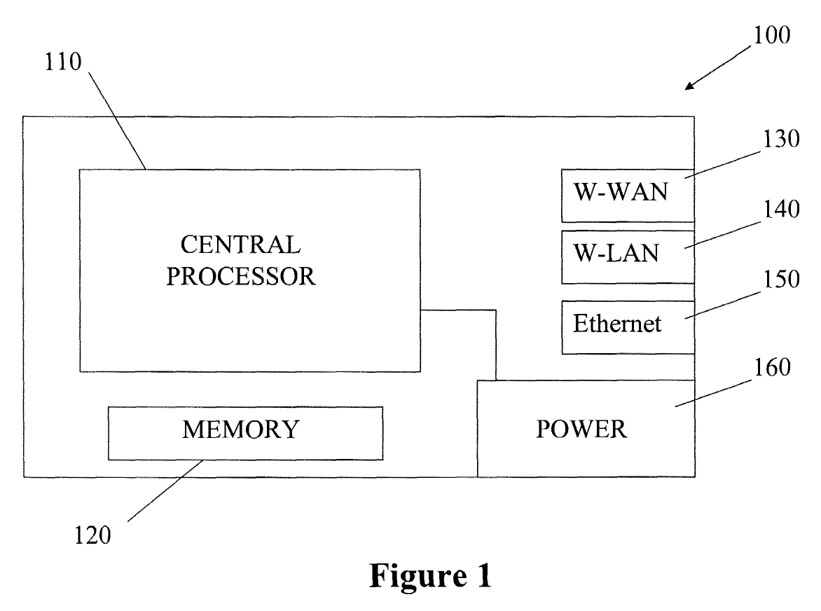

Referring to FIG. 1, an embodiment of a wireless device according to an embodiment of the present invention is illustrated. The wireless device may be a computer, such as a laptop computer, a personal digital assistant (PDA) or any other electronic device having wireless capability. FIG. 1 illustrates the wireless device 100 in a simplified manner and does not include all possible components which may be included in such devices.

The wireless device 100, or host, includes a central processing unit (CPU) 110 for execution and management of various processes and algorithms required to be executed by the wireless device 100. The CPU 110 is the primary processor for the wireless device 100.

The wireless device 100 is also provided with a data storage module 120. The data storage module 120 may be any practical type of memory. The particular type of memory may depend on the nature of the wireless device 100. The data storage module 120 can store a variety of information, such as programs and algorithms to be executed by the CPU 110, data required by and for execution of such programs and algorithms, or other data for use by a user, for example.

For communication with a network or other devices, the wireless device 100 may be provided with one or more communication modules. The device illustrated in FIG. 1 is provided with three such communication modules: a wireless wide area network (WWAN) module 130, a wireless local area network (WLAN) module 140, and a wired communication (Ethernet) module 150. Certain portable devices may include fewer, more or different communication modules. For example, certain portable devices, such as portable telephones, may not include an Ethernet module, but may include a Bluetooth module.

Each communication module 130, 140, 150 is linked to the CPU 110, which is also linked to the data storage module 120. Such linking may be direct or through a bus, depending on the architecture of the particular wireless device.

The wireless device 100 also includes a power supply 160, such as a rechargeable battery, to provide power for the CPU 110. The power supply 160 may also provide power to certain other components of the wireless device 100. In order to conserve power and to prolong the availability of the battery power, the CPU 110 is adapted to transition to a low-power or a power-off mode when not in active use. In this regard, the CPU may suspend all, some or most processes.

When in the CPU 110 is in the low-power or power-off mode, the WWAN module 130 may remain active. This may be achieved either by providing the WWAN module 130 with a separate power source or by using the power supply 160. The WWAN module 130 uses substantially less power than the CPU 110 and would not represent a substantially drain on the power supply 160.

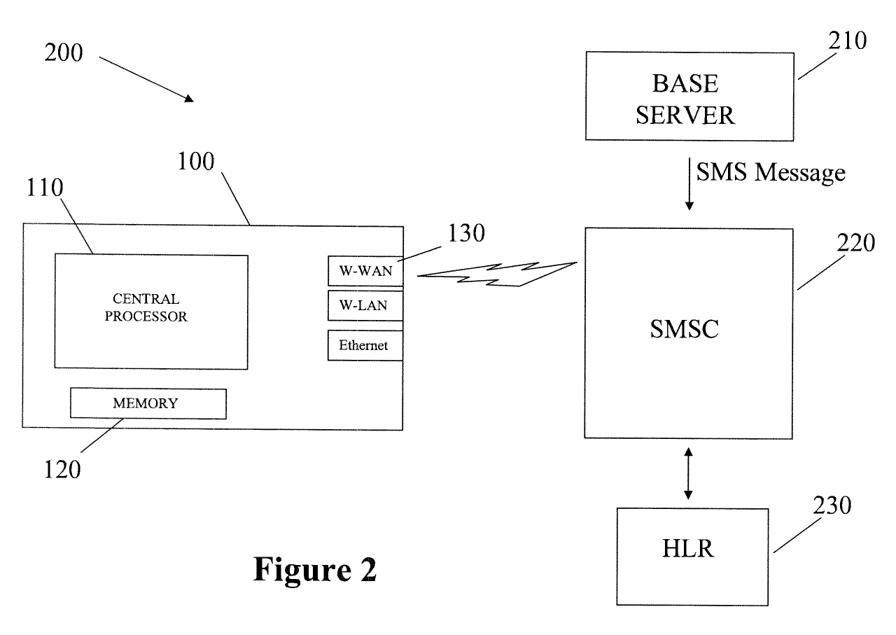

The WWAN module 130 of the wireless device 100 is adapted to receive wireless signals through a wide area network, such as the Internet or other communication networks. In one embodiment, the WWAN module 130 is adapted to receive messages through the Short Message Service (SMS). SMS messages are no longer than 160 alphanumeric characters long and can contain no images or graphics. FIG. 2 illustrates an embodiment of a system 200 through which SMS messages may be delivered to the wireless device 100.

A base server, such as a company's administrative server, may utilize SMS when, for example, it does not detect the wireless device 100 in its network (e.g., not connected to the wired network and not connected to a wireless local area network). In accordance with the Short Message Service, when the base server 210 wishes to send an SMS message to the wireless device 100, the message is first transmitted to a Short Message Service Center (SMSC) 220. Upon receiving the message, the SMSC 220 attempts to first locate the wireless device 100. This is achieved through a home location register (HLR) 230 which finds the roaming wireless device. Once the HLR 230 locates the wireless device 100, it notifies the SMSC 220, which then attempts delivery of the SMS message to the wireless device 100.

At the wireless device 100, the SMS message is received by the WWAN module 130. In accordance with embodiments of the present invention, the WWAN module 130 is adapted to process the SMS message to determine the appropriate action to be taken, if any. Thus, even if the CPU 110 of the wireless device 100 is in a low-power or power-off mode, the WWAN module 130 may be able to receive and process messages from the base server 210 or another device.

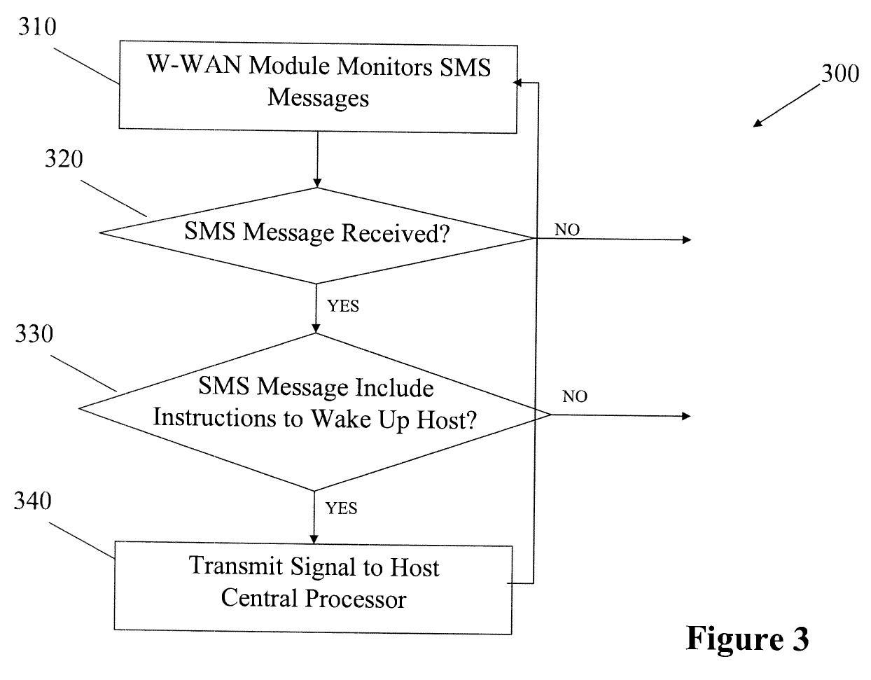

Referring now to FIG. 3, an embodiment of a method of remote operation of the wireless device 100 is described. The method 300 begins with the WWAN module 130 monitoring incoming SMS messages (blocks 310 and 320). When an SMS message is received, the WWAN module 130 determines whether the SMS message includes instructions to wake up the host (or the host central processor, CPU 110) (block 330). In this regard, the SMS message sent by the base server may include an explicit command to wake up the host. The message may include proper formatted syntax based on a standardization. In one embodiment, the SMS message may be formatted in such a way that follows the standards for Wake-on-LAN. However, for additional security, the security of CHAP challenge, RFC 1994 may be employed. Upon receipt of the SMS message, the WWAN module 130 decodes and validates the SMS message to ensure validity of the source.

If, after validation, the WWAN module 130 determines that the SMS message includes instructions to wake up the host, the WWAN module 130 transmits a signal to the CPU 110 to cause it to wake up (block 340). In this regard, the WWAN module 130 is adapted to toggle electrical pins associated with the CPU 110. The CPU 110 may monitor such electrical pins even though it is in a low-power or power-off mode.

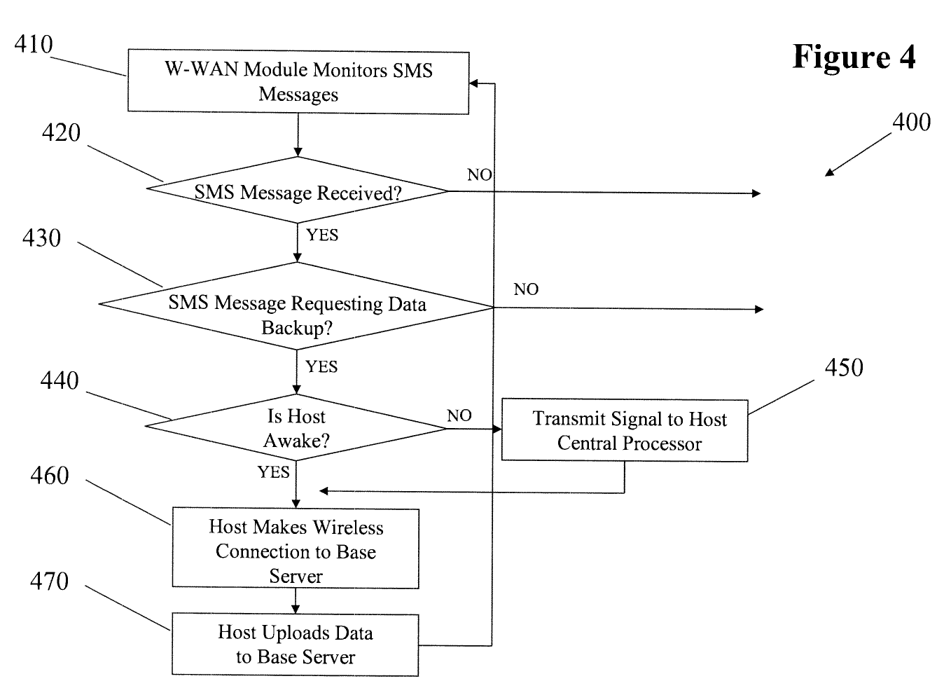

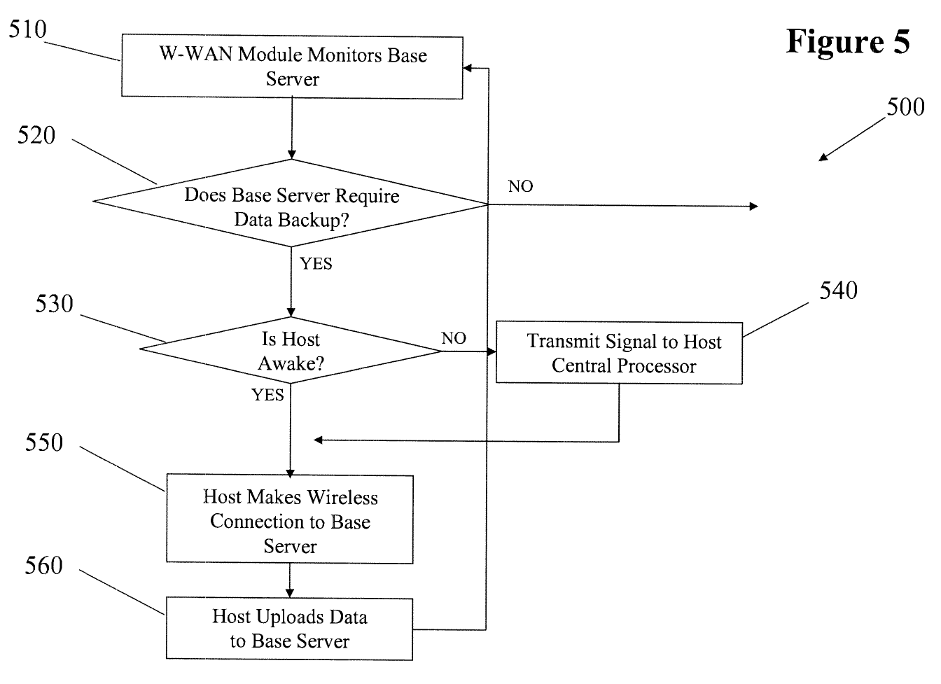

In other embodiments, such remote capability may be used to recover data from a lost or stolen electronic device, for example. FIGS. 4 and 5 illustrate embodiments of methods of remote operation according to embodiments of the present invention.

Referring first to FIG. 4, the method 400 begins with the WWAN module 130 monitoring incoming SMS messages (blocks 410 and 420). In this regard, although FIG. 4 illustrates the message as an SMS message, the message may also be a switched-packet message or other type of message.

When an SMS message is received, the WWAN module 130 determines whether the SMS message includes a request for backing up of data stored on the data storage module of the device (block 430). As described above, the WWAN module 130 is adapted to authenticate and validate the incoming SMS message.

Once the WWAN module 130 has verified the authenticity of the SMS message and determined that the message includes a request for a data backup, the WWAN module 130 determines whether the CPU 110 is awake or in a low-power or power-off mode (block 440). If the CPU 110 is awake, the method proceeds to block 460.

On the other hand, if the CPU 110 is in a low-power or power-off mode, the WWAN module transmits a signal to the CPU 110 to cause the CPU 110 to wake up (block 450), and the method proceeds to block 460.

At block 460, the wireless device makes a wireless connection to the base server. In this regard, the WWAN module 130 facilitates this wireless connection. In one embodiment, the wireless connection is an encrypted wireless connection. The data is then uploaded from the wireless device to the base server (block 470). The uploading of the data may be ordered by most recently changed. In this regard, the most recently updated files are uploaded first. In one embodiment, the uploading includes uploading only the changes since the last known backup. The uploading may be based on a directory structure. In a particular embodiment, only a predetermined set of data is uploaded from the wireless device to the base server.

Referring now to FIG. 5, another embodiment of a method of remote operation of the wireless device will be described. The method 500 begins with the WWAN module 130 monitoring the base server (blocks 410 and 420). In this regard, the WWAN module 130 may regularly and periodically poll the base server. A small client may be run on the WWAN module 130 which checks the status of a setting on the base server associated with a backup requirement. Thus, when the base server needs to backup data from the wireless device, the WWAN module 130 is able to detect such need.

When the WWAN module 130 determines that the base server needs to back up data from the wireless device 100, the WWAN module 130 determines whether the CPU 110 is awake or in a low-power or power-off mode (block 530). If the CPU 110 is awake, the method proceeds to block 550.

On the other hand, if the CPU 110 is in a low-power or power-off mode, the WWAN module transmits a signal to the CPU 110 to cause the CPU 110 to wake up (block 540), and the method proceeds to block 550.

At block 550, the wireless device makes a wireless connection to the base server. In this regard, the WWAN module 130 facilitates this wireless connection. The data is then uploaded from the wireless device to the base server (block 560).

In a variation of the embodiment of FIG. 5, the WWAN module 130 may monitor the geographic location of the wireless device 100. If the wireless device 100 is determined to be outside of a predetermined region (e.g., inside of an off-limits region), the WWAN module 130 may trigger a remote backup of the data.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A wireless communication method, comprising:
monitoring WWAN signals for a device while a primary processor of the device is in a low-power or power-off mode;
determining if a WWAN signal includes a message including instructions to wake up the device; and
transmitting a signal to the primary processor to wake up the device if the message includes said instructions to wake up the device.

2. The method of claim 1, wherein the message in the WWAN signal is an SMS message.

3. The method of claim 1, further comprising:
determining if the WWAN signal includes a message requesting data backup;
if the WWAN signal includes the message requesting data backup,
facilitating a wireless connection between the device and a base server associated with the WWAN signal; and
facilitating uploading of data from the device to the base server.

4. The method of claim 1, wherein the device is a portable computer.

5. The method of claim 1, wherein the device is a wireless communication device.

6. A wireless communication method, comprising:
monitoring WWAN signals for a device;
determining if a WWAN signal includes a message requesting data transfer from the device to a base server associated with the WWAN signal; and
facilitating a wireless connection between the device and the base server; and
facilitating uploading of data from the device to the base server.

7. The method of claim 6, further comprising:
determining if a primary processor of the device is in a low-power or power-off mode; and
transmitting a signal to the primary processor to wake up the device.

8. The method of claim 6, wherein the message in the WWAN signal is an SMS message.

9. The method of claim 6, wherein the device is a portable computer.

10. The method of claim 6, wherein the device is a wireless communication device.

11. The method of claim 6, wherein the uploading of data uses an encrypted wireless connection.

12. The method of claim 6, wherein the uploading of data is ordered by most recently changed.

13. The method of claim 6, wherein the uploading of data is includes changes from a last known backup.

14. The method of claim 6, wherein the uploading of data includes selecting files based on a directory structure.

15. The method of claim 6, wherein the uploading of data is includes uploading a predetermined set of data.

16. A wireless communication method, comprising:
monitoring, by a wireless module of an electronic device, a base server associated with the electronic device for need to back up data on the electronic device;
determining that a data backup is required;
facilitating a wireless connection between the electronic device and the base server; and
facilitating uploading of data from the electronic device to the base server.

17. The method of claim 16, further comprising:
determining if a primary processor of the device is in a low-power or power-off mode; and
transmitting a signal to the primary processor to wake up the device.

18. The method of claim 16, wherein the device is a portable computer.

19. The method of claim 16, wherein the device is a wireless communication device.

20. A wireless communication method, comprising:
determining, by a wireless module of an electronic device, that the electronic device is not within a pre-designated geographical region;
triggering a data backup of at least some data stored on the electronic device, the data backup comprising:
facilitating a wireless connection between the electronic device and the base server; and
facilitating uploading of data from the electronic device to the base server.

21. A wireless device, comprising:
a primary processor having a low-power or power-off mode; and
a wireless module adapted to monitor SMS messages from a base server to determine if the SMS messages include instructions to wake up the primary processor from the low-power or power-off mode;
wherein the wireless module is further adapted to transmit a signal to the primary processor to wake up the primary processor if the message includes said instructions to wake up the primary processor.

22. A wireless device, comprising:
a primary processor;
a data storage module; and
a wireless module adapted to monitor SMS messages from a base server to determine if the SMS messages include a request for a data transfer from the device to the base server;
wherein the wireless module is further adapted to facilitate a wireless connection between the device and the base server and to facilitate uploading of data from the device to the base server.

23. A wireless device, comprising:
a primary processor;
a data storage module; and
a wireless module adapted to monitor a base server for need to back up data on the wireless device;
wherein the wireless module is further adapted, when a data backup is required, to facilitate a wireless connection between the device and the base server and to facilitate uploading of data from the device to the base server.

24. A program product, comprising machine-readable program code for causing, when executed, one or more machines to perform the following method steps:
monitoring WWAN signals for a device while a primary processor of the device is in a low-power or power-off mode;
determining if a WWAN signal includes a message including instructions to wake up the device; and
transmitting a signal to the primary processor to wake up the device if the message includes said instructions to wake up the device.

25. A program product, comprising machine-readable program code for causing, when executed, one or more machines to perform the following method steps:
monitoring WWAN signals for a device;
determining if a WWAN signal includes a message requesting data transfer from the device to a base server associated with the WWAN signal; and
facilitating a wireless connection between the device and the base server; and
facilitating uploading of data from the device to the base server.

26. A program product, comprising machine-readable program code for causing, when executed, one or more machines to perform the following method steps:
monitoring, by a wireless module of an electronic device, a base server associated with the electronic device for need to back up data on the electronic device;
determining that a data backup is required;
facilitating a wireless connection between the electronic device and the base server; and
facilitating uploading of data from the electronic device to the base server.
